(19) United States
(12) Patent Application Publication
(10) Pub. No.: US 2025/0383518 A1
(43) Pub. Date: Dec. 18, 2025

(54) OPTICAL MODULE

(71) Applicant: NEC Corporation, Tokyo (JP)

(72) Inventors: Hiroki YASUDA, Tokyo (JP); Taro KANEKO, Tokyo (JP)

(73) Assignee: NEC Corporation, Tokyo (JP)

(21) Appl. No.: 19/228,984

(22) Filed: Jun. 5, 2025

(30) Foreign Application Priority Data
Jun. 18, 2024 (JP) 2024-097948

(51) Int. Cl. G02B 6/42

(52) U.S. Cl. CPC G02B 6/4286; G02B 6/4204; G02B 6/4271

(57) ABSTRACT

An optical module according to the present disclosure includes a light output unit that outputs light, a lens including an incident face on which the light output from the light output unit is incident and an emission face having a first emission portion that emits the light incident on the incident face, and a light receiving element that receives light refracted by the incident face.

### INCORPORATION BY REFERENCE

This application is based upon and claims the benefit of priority from Japanese patent application No. 2024-097948, filed on Jun. 18, 2024, the disclosure of which is incorporated herein in its entirety by reference.

### TECHNICAL FIELD

The present disclosure relates to an optical module.

### BACKGROUND ART

In an optical transceiver, an optical module referred to as a transmitter optical subassembly (TOSA) is used to transmit an optical signal.

As a related art related to an optical module such as the TOSA, there is an optical module disclosed in Patent Literature 1.

According to the optical module disclosed in Patent Literature 1, light output from the light emitting element transmits a first lens corresponding to a collimating lens, and is reflected by a reflecting surface existing at a subsequent stage relative to the first lens. Reflected light reflected by the reflecting surface is condensed and received by a light receiving element corresponding to a monitor photo diode (PD), whereby optical power is monitored by the light receiving element.
[Patent Literature 1] JP 2008-004916 A

### SUMMARY

Meanwhile, in recent years, an optical module such as the TOSA is required to be downsized in order to cope with further spread of optical communication and to secure competitiveness against competitors.

However, since the optical module disclosed in Patent Literature 1 is configured to use light reflected by the reflecting surface, it is necessary to provide the reflecting surface. Since it is necessary to change the path of the light output from the light emitting element and the path of the reflected light reflected by the reflecting surface, the path of the light is long. Therefore, it is difficult to downsize the optical module.

In view of the above problems, an example object of the present disclosure is to provide an optical module that can be downsized.

An optical module according to an example aspect includes
a light output unit that outputs light,
a lens including an incident face on which the light output from the light output unit is incident and an emission face having a first emission portion that emits the light incident on the incident face, and
a light receiving element that receives light refracted by the incident face.

According to the above aspect, it is possible to provide an optical module that can be downsized.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating a configuration example of an optical module according to a related art;

FIG. 2 is a diagram illustrating a configuration example of a light emitting element according to the present disclosure;

FIG. 3 is a diagram illustrating a specific configuration example of the light emitting element illustrated in FIG. 2;

FIG. 4 is a view illustrating a configuration example of a light emitting element according to the present disclosure;

FIG. 5 is a diagram illustrating a configuration example of an optical module according to the present disclosure;

FIG. 6 is a diagram illustrating an implementation example of an optical module according to a related art;

FIG. 7 is a view illustrating an implementation example of the optical module according to the present disclosure;

FIG. 8 is a diagram illustrating a configuration example of the optical module according to the present disclosure;

FIG. 9 is a diagram illustrating a configuration example of the optical module according to the present disclosure; and

FIG. 10 is a diagram illustrating a configuration example of the optical module according to the present disclosure.

### EXAMPLE EMBODIMENT

Hereinafter, example embodiments of the present disclosure will be described with reference to the drawings. In the following description and drawings, omission and simplification are made, as appropriate, for clarity of explanation. In the following drawings, the same elements are denoted by the same reference signs, and redundant description will be omitted as necessary. In the following description, it is assumed that the optical module is the TOSA, but an example of the optical module is not limited to the TOSA.

### Related Art

Prior to describing each example embodiment of the present disclosure, a related art will be described.

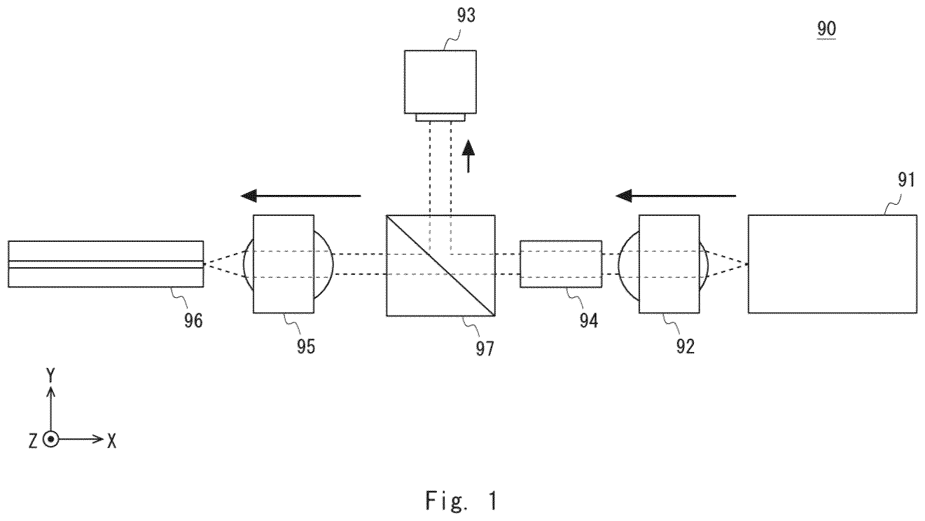

FIG. 1 is a diagram illustrating a configuration example of an optical module 90 according to a related art. The optical module 90 is an optical module studied by the present inventors and the like, and is not the optical module disclosed in Patent Literature 1.

As illustrated in FIG. 1, the optical module 90 includes a light emitting element 91, a collimating lens 92, an isolator 94, a prism 97, a monitor PD 93, a condenser lens 95, and an optical fiber 96. In FIG. 1, the light path is indicated by a dotted line (the same applies to the following drawings).

The light emitting element 91 is an element that outputs light.

The collimating lens 92 is a lens that collimates the light output from the light emitting element 91.

The isolator 94 is an element that reduces return light returning to the collimating lens 92 among light output from the collimating lens 92 and passing through the isolator 94.

The prism 97 is an element that branches the light output from the isolator 94 to output the branched light to the monitor PD 93 and the condenser lens 95. As illustrated in FIG. 1, the prism 97 may include a semitransparent mirror that transmits and reflects incident light at a constant ratio. In this case, the prism 97 outputs the reflected light and the transmitted light to the monitor PD 93 and the condenser lens 95, respectively.

The monitor PD 93 is an element that receives light branched by the prism 97 and monitors optical power of the received light. For example, a control unit (not illustrated) adjusts the optical power of the light output from the light emitting element 91 based on the optical power monitored by the monitor PD 93.

The condenser lens 95 is a lens that condenses the light output from the prism 97 on the optical fiber 96.

The optical fiber 96 is an optical fiber that propagates the light output from the condenser lens 95.

As described above, the optical module 90 is required to be downsized. In each example embodiment described below, the prism 97 constituting the optical module 90 is removed, so that the optical module is downsized.

### <Precondition Configuration of Each Example Embodiment>

Next, a precondition configuration of the first and second example embodiments among the example embodiments described below will be described.

In the first and second example embodiments, it is assumed that a light emitting element having the following functions is used.
Light is tilted to output with respect to a collimating lens at the subsequent stage. For example, the light emitting element emits light at an angle that is not parallel to the optical axis of the collimating lens.
It has an emission angle (for example, an angle formed by the optical axis of the collimating lens and the traveling direction of the light output from the light emitting element) and a divergence angle of light. The emission angle and the divergence angle of the light may be large.

In the first and second example embodiments, it is assumed that a collimating lens having the following functions is used.
The lens diameter is such that leakage light is generated by refraction of part of light tilted to output from the light emitting element.

An example of the light emitting element used in the first and second example embodiments will be described. Two light emitting elements 11X and 11Y are taken as an example.

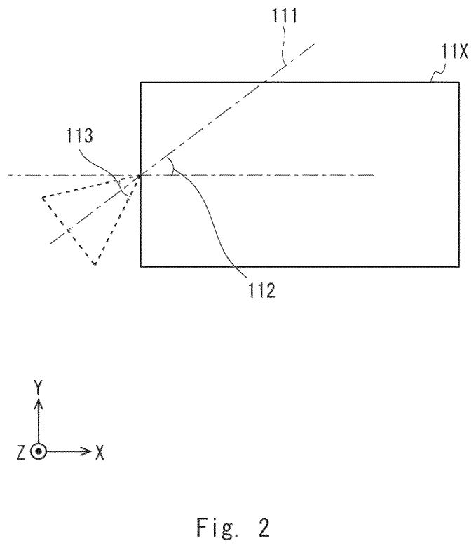

FIG. 2 is a diagram illustrating a configuration example of the light emitting element 11X according to the present disclosure.

As illustrated in FIG. 2, the light emitting element 11 has an optical axis 111 inclined, and is configured to output light in a direction of the inclined optical axis 111. Therefore, the light emitting element 11X outputs the light inclined to the collimating lens at the subsequent stage.

The light emitting element 11X has a configuration in which an emission angle 112 and a divergence angle 113 of light are large.

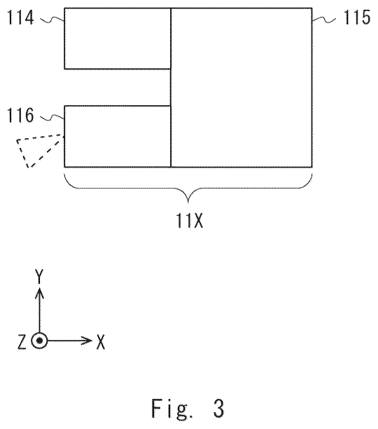

FIG. 3 is a diagram illustrating a specific configuration example of the light emitting element 11X illustrated in FIG. 2.

As illustrated in FIG. 3, for example, the light emitting element 11X may include a semiconductor optical amplifier (SOA) 114, a silicon photonics (SiPh) chip 115, and a booster optical amplifier (BOA) 116.

The SOA 114 is a light source that outputs light.

The SiPh chip 115 is a chip that performs various processes including wavelength adjustment, modulation, and the like on the light output from the SOA 114.

The BOA 116 is an amplifier that amplifies and outputs the light output from the SiPh chip 115.

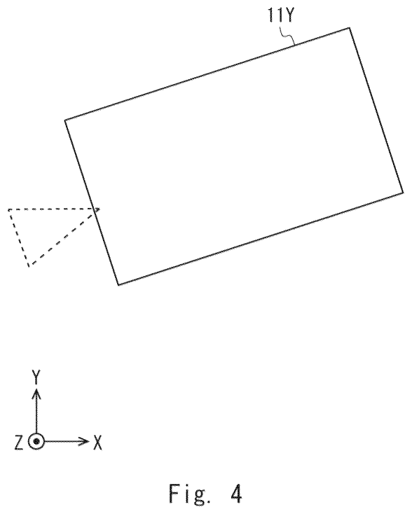

FIG. 4 is a diagram illustrating a configuration example of the light emitting element 11Y according to the present disclosure.

As illustrated in FIG. 4, in the light emitting element 11Y, the light emitting element 11Y itself is installed in an inclined manner. Therefore, the light emitting element 11Y outputs the light inclined to the collimating lens at the subsequent stage.

The light emitting element 11Y has a configuration in which the emission angle 112 and the divergence angle 113 of light are large, as in the light emitting element 11X.

In the first and second example embodiments described below, both the light emitting elements 11X and 11Y can be used, but in consideration of the mounting area and the like, it is preferable to use the light emitting element 11X. Therefore, in the first and second example embodiments, it is assumed that the light emitting element 11X is used.

Hereinafter, each example embodiment including the first and second example embodiments will be described.

### First Example Embodiment

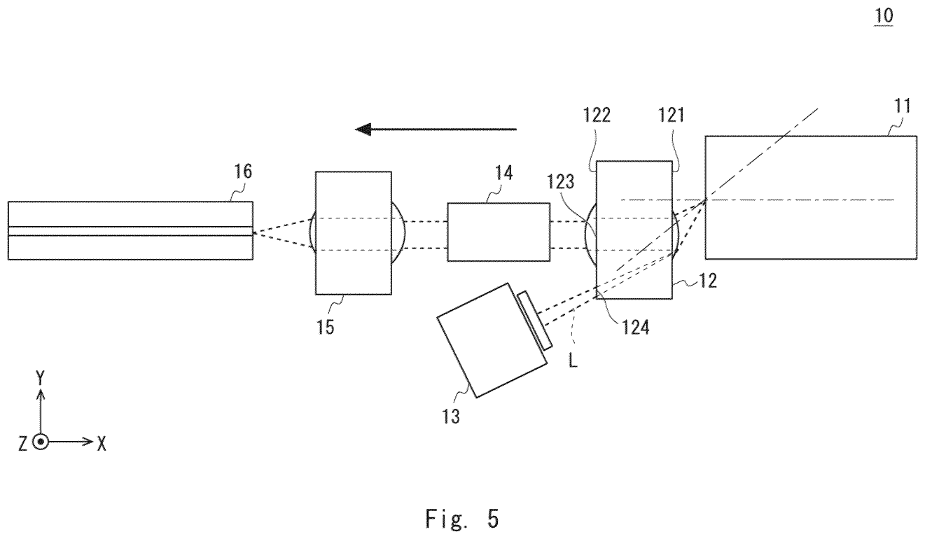

FIG. 5 is a diagram illustrating a configuration example of an optical module 10 according to the present disclosure.

As illustrated in FIG. 5, the optical module 10 includes a light emitting element 11, a collimating lens 12, a monitor PD 13, an isolator 14, a condenser lens 15, and an optical fiber 16.

The light emitting element 11 is an element that outputs light, and is achieved by the light emitting element 11X. Therefore, the light emitting element 11 has the optical axis 111 inclined to output the light inclined to the collimating lens 12 at the subsequent stage. In the light emitting element 11, an emission angle 112 and a divergence angle 113 of light are large.

The collimating lens 12 is a lens that collimates the light output from the light emitting element 11, and includes an incident face 121 on which the light output from the light emitting element 11 is incident, and an emission face 122 having a first emission portion 123 that emits the light in which the light incident on the incident face 121 is collimated. As illustrated in FIG. 5, the direction in which the first emission portion 123 emits light is different from the direction of the optical axis 111 of the light emitting element 11.

The lens diameter of the collimating lens 12 is a lens diameter in such a way that part of light output from the light emitting element 11 inclined is refracted by the incident face 121 to generate leakage light L.

In the optical module 10, the light refracted by the incident face 121 is emitted from a second emission portion 124 at a position different from the first emission portion 123 among the positions on the emission face 122, and becomes the leakage light L. The optical power of the leakage light L is about 0.2 to 0.5 [dB].

Therefore, in the optical module 10, the monitor PD 13 is installed near the collimating lens 12 and on the minus side in the X direction and on the minus side in the Y direction as viewed from the collimating lens 12, and the monitor PD 13 receives the leakage light L and monitors the optical power of the leakage light L. For example, a control unit (not illustrated) adjusts the optical power of the light output from the light emitting element 11 based on the optical power monitored by the monitor PD 13. As a result, in the optical module 10, the prism 97 constituting the optical module 90 can be removed.

The position of the monitor PD 13 illustrated in FIG. 5 is an example. For example, the leakage light L may be output from the collimating lens 12 to the minus side in the X direction and to the plus side in the Y direction. In such a case, the monitor PD 13 may be disposed on the minus side in the X direction and on the plus side in the Y direction as viewed from the collimating lens 12.

The isolator 14 is an element that reduces return light that returns to the collimating lens 12 among light that is output from the first emission portion 123 of the collimating lens 12 and has passed through the isolator 14.

The condenser lens 15 is a lens that condenses the light output from the isolator 14 on the optical fiber 16.

The optical fiber 16 is an optical fiber that propagates the light output from the condenser lens 15.

As described above, the functions of the isolator 14, the condenser lens 15, and the optical fiber 16 of the optical module 10 are substantially similar to the functions of the isolator 94, the condenser lens 95, and the optical fiber 96 of the optical module 90.

As described above, according to the first example embodiment, the optical module 10 is configured in such a way that the leakage light L refracted by the incident face 121 of the collimating lens 12 and emitting from the second emission portion 124 of the collimating lens 12 is received by the monitor PD 13.

As a result, the optical module 10 can remove the prism 97 constituting the optical module 90 according to the related art. As a result, the optical module 10 can be downsized as compared with the optical module 90 according to the related art. Since the prism 97 is removed, the component cost and the mounting cost of the prism 97 can be removed. As a result, the optical module 10 can achieve cost reduction as compared with the optical module 90 according to the related art. In the optical module 10, the optical power of the light extracted for monitoring the optical power by the monitor PD 13 is about 0.2 to 0.5 [dB] that is equivalent to that in the case of using the prism 97. Therefore, the optical module 10 can be reduced in size and cost without increasing the optical loss for the entire optical module as compared with the optical module 90 according to the related art.

Since the optical module 10 makes it possible to remove the prism 97, the influence of the mounting error caused by the mounting of the prism 97 is eliminated. The influence of the positional deviation and the angular deviation of the prism 97 caused by temperature change is eliminated. As a result, the optical module 10 can suppress fluctuation of the light output to the optical fiber 16 as compared with the optical module 90 according to the related art.

Since the optical module 10 can control the temperature of all the basic components constituting the optical module 90 as compared with the optical module 10 according to the related art, it is also possible to improve reliability. Hereinafter, this effect will be described.

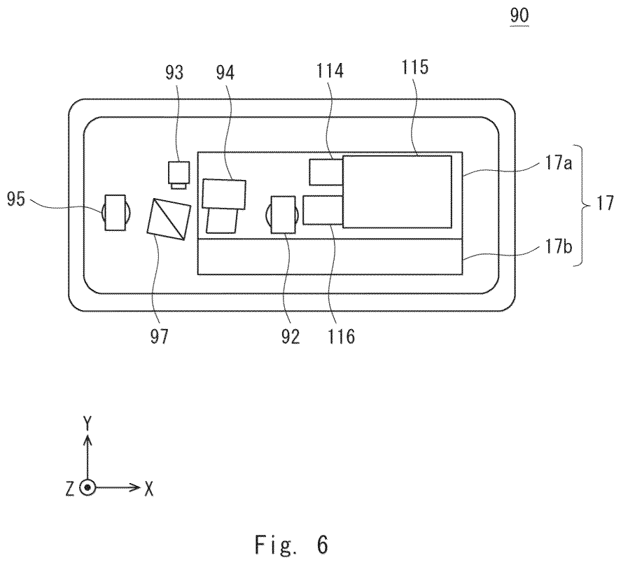

FIG. 6 is a diagram illustrating an implementation example of the optical module 90 according to the related art. In the example of FIG. 6, light emitting element 91 constituting optical module 90 is achieved by the light emitting element 11X illustrated in FIG. 3. In the example of FIG. 6, the optical fiber 96 is omitted.

As illustrated in FIG. 6, the optical module 90 includes a thermoelectric cooler (TEC) 17, and is capable of controlling a temperature of components disposed on the TEC 17. The TEC 17 has a stage in the Z direction, and includes an upper stage 17a and a lower stage 17b. The TEC 17 has a size (size in the X direction and size the Y direction) of a general-purpose product determined in advance, and if it is a custom-made product, the size can be increased, but the cost is high. Therefore, in consideration of cost, it is preferable to use a general-purpose product as the TEC 17.

However, since the optical module 90 is provided with the prism 97, it is difficult to downsize the optical module. Therefore, among the components constituting the optical module 90, the monitor PD 93, the condenser lens 95, and the prism 97 cannot be disposed on the TEC 17.

As a result, in the optical module 90, components disposed on the TEC 17 and components not disposed on the TEC 17 are mixed. In this case, if there is a temperature change, the amount of positional deviation is different between the component disposed on the TEC 17 and the component not disposed on the TEC 17, and thus, the fluctuation of the light output to the optical fiber 96 is large.

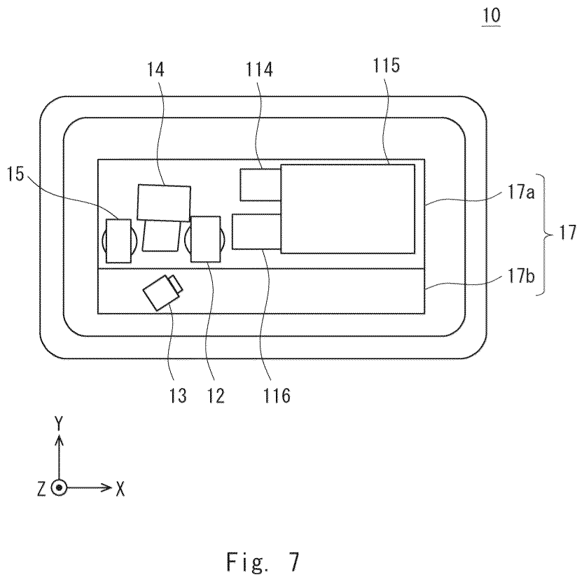

FIG. 7 is a diagram illustrating an implementation example of the optical module 10 according to the present disclosure. Also in the example of FIG. 7, the light emitting element 11 constituting the optical module 10 is achieved by the light emitting element 11X illustrated in FIG. 3. In the example of FIG. 7, the optical fiber 16 is omitted.

As illustrated in FIG. 7, since the optical module 10 has a configuration in which the prism 97 is removed, the optical module can be downsized. Therefore, all the basic components constituting the optical module 10 can be disposed on the TEC 17. Specifically, in the example of FIG. 7, the light emitting element 11, the collimating lens 12, the isolator 14, and the condenser lens 15 are disposed in the upper stage 17a of the TEC 17, and the monitor PD 13 is disposed in the lower stage 17b of the TEC 17. The TEC 17 corresponds to a temperature control element.

As a result, since the optical module 10 can control the temperature of all the basic components constituting the optical module 10, it is possible to suppress the fluctuation of the light output to the optical fiber 16 even if the temperature changes. As a result, the optical module 10 can improve reliability.

The advantageous effects of the optical module 10 have been described above as compared with the optical module 90 according to the related art. However, the optical module 10 can also obtain an advantageous effect as compared with the optical module disclosed in Patent Literature 1.

Specifically, in the optical module 10, since the monitor PD 13 can be installed in the vicinity of the collimating lens 12, the path of light is simpler than that of the optical module disclosed in Patent Literature 1, and there is no need to provide a reflecting surface. As a result, the optical module 10 can be downsized as compared with the optical module disclosed in Patent Literature 1. Since the optical module 10 has a simple light path as compared with the optical module disclosed in Patent Literature 1, it is easy to design, and it is not necessary to prepare a component having a complicated structure. As a result, the optical module 10 can achieve cost reduction as compared with the optical module disclosed in Patent Literature 1.

### Second Example Embodiment

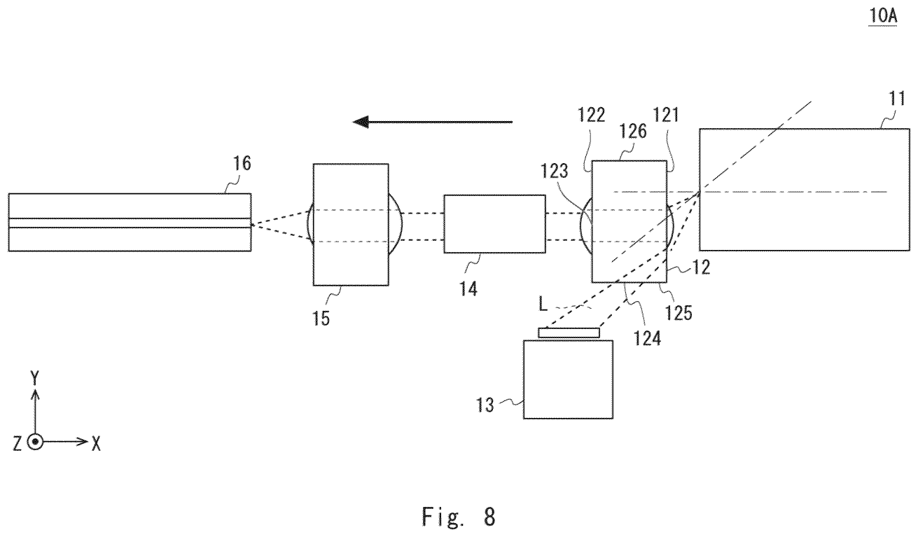

FIG. 8 is a diagram illustrating a configuration example of an optical module 10A according to the present disclosure.

As illustrated in FIG. 8, the optical module 10A is different from the optical module 10 in the installation position of the monitor PD 13.

In the optical module 10, the leakage light L is emitted from the second emission portion 124 on the emission face 122. Therefore, the monitor PD 13 is installed near the collimating lens 12 and on the minus side in the X direction and on the minus side in the Y direction as viewed from the collimating lens 12, and is configured to receive the leakage light L.

On the other hand, in the optical module 10A, the leakage light L is emitted from the second emission portion 124 located at a side face 125 at least one side of which is shared with the incident face 121 and the emission face 122. Therefore, the monitor PD 13 is installed in the vicinity of the collimating lens 12 and on the minus side in the Y direction as viewed from the collimating lens 12, and is configured to receive the leakage light L.

The position of the monitor PD 13 illustrated in FIG. 8 is an example. For example, there is a case where the leakage light L is output from the collimating lens 12 in the plus side in the Y direction, that is, there is a case where the leakage light L is output from the second emission portion 124 (not illustrated) located at the side face 126 opposite to the side face 125. In such a case, the monitor PD 13 may be disposed on the plus side in the Y direction as viewed from the collimating lens 12.

The optical module 10A is different from the optical module 10 only in the installation position of the monitor PD 13, and other structures are similar to those of the optical module 10. Therefore, the optical module 10A can obtain the same effect as the optical module 10.

### Third Example Embodiment

The third example embodiment corresponds to an example embodiment that is a superordinate concept of the first example embodiment described above.

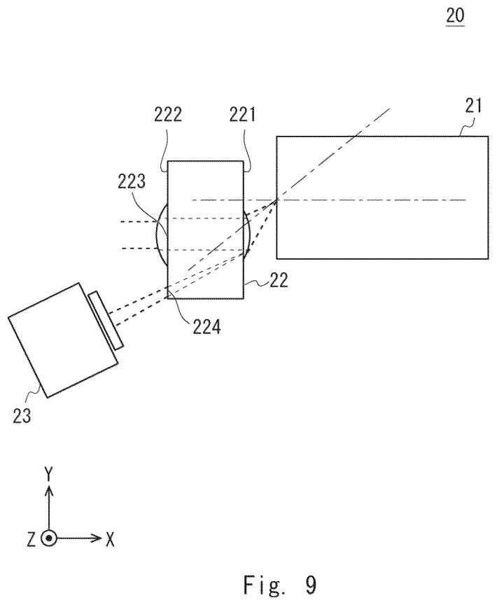

FIG. 9 is a diagram illustrating a configuration example of an optical module 20 according to the present disclosure.

As illustrated in FIG. 9, the optical module 20 includes a light output unit 21, a lens 22, and a light receiving element 23.

The light output unit 21 outputs light. The light output unit 21 corresponds to the light emitting element 11.

Lens 22 includes an incident face 221 on which the light output from light output unit 21 is incident, and an emission face 222 having a first emission portion 223 that emits the light incident on incident face 221. The lens 22 corresponds to the collimating lens 12.

The light receiving element 23 receives the light refracted by the incident face 221. The light receiving element 23 corresponds to the monitor PD 13.

The position of the light receiving element 23 illustrated in FIG. 9 is an example. For example, the light refracted by the incident face 221 may be output from the lens 22 to the minus side in the X direction and to the plus side in the Y direction. In such a case, the light receiving element 23 may be disposed on the minus side in the X direction and on the plus side in the Y direction as viewed from the lens 22.

As described above, according to the third example embodiment, the optical module 20 is configured in such a way that the light refracted by the incident face 221 of the lens 22 is received by the light receiving element 23. Thus, the optical module 20 can be downsized. Specifically, since a prism (for example, the prism 97 constituting the optical module 90 according to the related art, and the like) for branching light to the light receiving element 23 is unnecessary, the optical module 20 can be downsized. Since the component cost and the mounting cost of the prism are eliminated, the cost of the optical module 20 can be reduced. In the optical module 20, the optical power of the light received by the light receiving element 23 is about 0.2 to 0.5 [dB] that is equivalent to that in the case of using the prism. Therefore, the optical module 20 can be reduced in size and cost without increasing the optical loss in the entire optical module, as compared to a case where a prism is used.

The light output unit 21 outputs light in an inclined optical axis direction. On the other hand, the first emission portion 223 emits light in a direction different from the optical axis direction.

In the lens 22, the light refracted by the incident face 221 is output from the second emission portion 224 provided at a position different from the first emission portion 223.

In the optical module 20, the second emission portion 224 is located at the emission face 222.

Therefore, the light receiving element 23 is installed near the lens 22 and on the minus side in the X direction and on the minus side in the Y direction as viewed from the lens 22, and receives the light refracted by the incident face 221 and emitting from the second emission portion 224.

### Fourth Example Embodiment

The fourth example embodiment corresponds to an example embodiment that is a superordinate concept of the above-described second example embodiment.

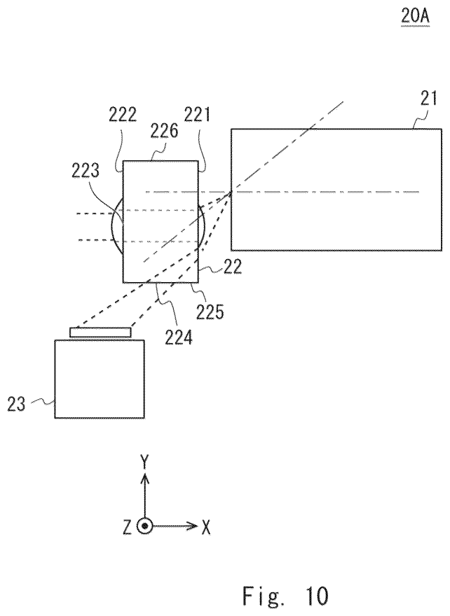

FIG. 10 is a diagram illustrating a configuration example of an optical module 20A according to the present disclosure.

As illustrated in FIG. 10, the optical module 20A is different from the optical module 20 in the installation position of the light receiving element 23.

In the optical module 20A, the second emission portion 224 is located at a side face 225 at least one side of which is shared with the incident face 221 and the emission face 222.

Therefore, the light receiving element 23 is installed near the lens 22 and on the minus side in the Y direction as viewed from the lens 22, and receives the light refracted by the incident face 221 and emitting from the second emission portion 224.

The position of the light receiving element 23 illustrated in FIG. 10 is an example. For example, there is a case where the light refracted by the incident face 221 is output from the lens 22 to the plus side in the Y direction, that is, there is a case where the light is output from the second emission portion 224 (not illustrated) located at the side face 226 opposite to the side face 225. In such a case, the light receiving element 23 may be disposed on the plus side in the Y direction as viewed from the lens 22.

The optical module 20A is different from the optical module 20 only in the installation position of the light receiving element 23, and other structures are similar to those of the optical module 20. Therefore, the optical module 20A can obtain the same effect as the optical module 20.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

The position tolerance of each of the monitor PD 13 and the light receiving element 23 may be improved by providing appropriate roughness on the surface from which the monitor light is emitted and scattering the light. Specifically, the divergence angle of the light emitting from the second emission portion 124, 224 is increased. As a result, the position tolerance of each of the monitor PD 13 and the light receiving element 23 is improved. For example, the divergence angle of the light emitting from the second emission portion 124, 224 is larger than the divergence angle of the light emitting from the first emission portion 123, 223.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

An optical module including
a light output unit that outputs light,
a lens including an incident face on which the light output from the light output unit is incident and an emission face having a first emission portion that emits the light incident on the incident face, and
a light receiving element that receives light refracted by the incident face.

### Supplementary Note 2

The optical module according to Supplementary Note 1, wherein
the light output unit outputs light in an optical axis direction, and
the first emission portion emits light incident on the incident face in a direction different from the optical axis direction.

### Supplementary Note 3

The optical module according to Supplementary Note 1, wherein
the lens includes a second emission portion provided at a position different from a position of the first emission portion, and
the light receiving element receives light refracted by the incident face and emitting from the second emission portion.

### Supplementary Note 4

The optical module according to Supplementary Note 3, wherein the second emission portion is located at the emission face.

### Supplementary Note 5

The optical module according to Supplementary Note 3, wherein the second emission portion is located at a side face at least one side of which is shared with the incident face and the emission face.

### Supplementary Note 6

The optical module according to Supplementary Note 3, wherein a divergence angle of light emitting from the second emission portion is larger than a divergence angle of light emitting from the first emission portion.

### Supplementary Note 7

The optical module according to Supplementary Note 1, further including
an isolator through which light emitting from the first emission portion of the lens passes,
a condenser lens that condenses the light passing through the isolator,
an optical fiber that propagates the light condensed by the condenser lens, and
a temperature control element capable of controlling a temperature,
wherein the light output unit, the lens, the light receiving element, the isolator, and the condenser lens are disposed on the temperature control element.

What is claimed is:

1. An optical module comprising:
a light output unit that outputs light;
a lens including an incident face on which the light output from the light output unit is incident and an emission face having a first emission portion that emits the light incident on the incident face; and
a light receiving element that receives light refracted by the incident face.

2. The optical module according to claim 1, wherein
the light output unit outputs light in an optical axis direction, and
the first emission portion emits light incident on the incident face in a direction different from the optical axis direction.

3. The optical module according to claim 1, wherein
the lens includes a second emission portion provided at a position different from a position of the first emission portion, and
the light receiving element receives light refracted by the incident face and emitting from the second emission portion.

4. The optical module according to claim 3,
wherein the second emission portion is located at the emission face.

5. The optical module according to claim 3, wherein the second emission portion is located at a side face at least one side of which is shared with the incident face and the emission face.

6. The optical module according to claim 3, wherein a divergence angle of light emitting from the second emission portion is larger than a divergence angle of light emitting from the first emission portion.

7. The optical module according to claim 1, further comprising:
an isolator through which light emitting from the first emission portion of the lens passes;
a condenser lens that condenses the light passing through the isolator;
an optical fiber that propagates the light condensed by the condenser lens; and
a temperature control element capable of controlling a temperature,
wherein the light output unit, the lens, the light receiving element, the isolator, and the condenser lens are disposed on the temperature control element.
